(19) United States
(12) Patent Application Publication
(10) Pub. No.: US 2016/0201599 A1
(43) Pub. Date: Jul. 14, 2016

(54) METHOD AND THERMAL ENGINE FOR UTILIZING WASTE HEAT OR GEOTHERMAL HEAT

(71) Applicant: Berta RICHTER, Augsburg (DE)

(72) Inventor: Hans RICHTER, Augsburg (DE)

(21) Appl. No.: 14/948,258

(22) Filed: Nov. 21, 2015

Related U.S. Application Data
(63) Continuation-in-part of application No. PCT/EP2014/001347, filed on May 20, 2014.

(30) Foreign Application Priority Data
May 21, 2013 (DE) 13002654.5

(51) Int. Cl. F02G 1/047; F02G 1/055

(52) U.S. Cl. CPC F02G 1/047; F02G 1/055

(57) ABSTRACT

In a thermal engine for producing an electrical current or mechanical output by actuating a piston by gas under pressure in a cylinder chamber of the thermal engine, wherein heat is applied to the gas compressed in the cylinder by injecting or spraying a heat transfer medium in the form of a hot liquid or hot condensable gas into the cylinder chamber from which the used heat transfer medium is then collected in a base region of the cylinder chamber and is drained into a collection chamber.

This is a Continuation-In-Part application of pending international patent application PCT/EP2014/001347 filed May 20, 2014 and claiming the priority of German patent application 13 002 654.2 filed May 21, 2013.

### BACKGROUND OF THE INVENTION

The invention resides in a method and a modified thermal engine for the utilization of waste heat or geothermal heat or, in general terms, of heat of a relatively low temperature level, in particular in a temperature range extending about to the boiling point of water, especially for the generation of electricity. Such categories of heat cannot so far be utilized for the generation of electricity or, generally for the generation or power since conventional engines for driving electric generators cannot be operated thereby.

In contrast to common piston engines or gas and steam turbines, a hot gas thermal engine operates with a gas which remains within the engine, not with gas which is being exchanged.

A hot gas engine in the form of a Stirling engine is known. A Stirling engine which always requires two piston includes a permanently heated cylinder area and a permanently cooled cylinder chamber between which the operating gas is moved back and forth. In the heated cylinder chamber, the operating gas expands and generates power in the cooled cylinder chamber, the operating gas contracts again.

In the known Stirling engine, it is disadvantageous that all the heat for heating the hot cylinder chamber needs to be supplied through the thick cylinder wall which, although permitting the use of any type of heat that can be supplied through the cylinder wall, causes a substantial inertia of the Stirling engine. This inertia is enhanced by the fact that the operating gas has to be moved in each cycle between the hot cylinder chamber and the cold cylinder chamber through relatively narrow channels. Furthermore, the hot areas and the cold areas cannot be switched in the Stirling engine. Large amounts of energy can therefore be handled by the Stirling engine.

It is the object of the present invention to provide a method and a modified hot gas thermal engine which permits the conversion of substantial amounts of energy and which in particular facilitates a substantially more intense heat input for the generation of mechanical power in particular for the generation of electricity.

It is in particular the object of the present invention to facilitate an effective utilization of waste heat or relatively low temperature heat which can generally only be used for heating purposes.

### SUMMARY OF THE INVENTION

In a thermal engine for producing an electrical current or mechanical output by actuating a piston by gas under pressure in a cylinder chamber of the thermal engine wherein heat is applied to the gas compressed in the cylinder by injecting or spraying a hot liquid or hot condensable heat transfer medium into the cylinder chamber from which the used heat transfer medium is then collected in a base region of the cylinder chamber and is drained into a collection chamber.

Because the heat carrier medium, preferably hot water, is injected directly into the cylinder chambers, the heat input into the cylinder chamber of the hot gas thermal engine according to the invention occurs directly from molecule to molecule and without delay. The amount of heat no longer depends on the size of the cylinder surface but can be controlled by the amount of the heat carrier medium injected. In this way, with a correspondingly large cylinder chamber substantially more heat per time unit can be introduced into the cylinder chamber than would be possible by heat conduction through the cylinder wall alone.

The liquid heat carrier medium can preferably be heated by waste heat. The waste heat may for example be derived from cooling towers of power generation plants in that the heat of the cooling water heated during passage through the cooling tower is used in the thermal power engine as heat supply. In this way, waste heat which has not been useable is converted to useable energy which, at the same time reduced environmental impacts. Also, other types of waste heat from industrial processes can be converted into useable energy.

The modified hot gas thermal engine according to the present invention differs from the principle of the known Stirling engine in an essential way in that heat is supplied not view heat transfer through the cylinder wall but by direction injection of a liquid heat carrier medium into a cylinder, chamber. The liquid is injected in the form of a droplet cloud so that the liquid heat carrier medium comes rapidly into intensive contact with the gas in the cylinder chamber and the heat exchange between the heat carrier medium and the gas occurs rapidly and intensely. As a result of the gravity, the droplets are then separated from the heated gas and the heat carrier liquid, which has been cooled by the heat exchange, is collected in the bottom area of the cylinder chamber and flows from there through openings into a liquid collection chamber. The pressurized gas in the cylinder is further expanded by the heat input from the injected liquid heat carrier medium and drives the piston either along the cylinder if a reciprocating piston is used or along a circular path if a rotating piston is used. The gas than had been heated by the heat transfer from the heat carrier medium is now cooled by power generation as well as by the cylinder walls which are cooled and then can be reheated by a hew heat input.

The heat carrier medium needs to be liquid so that it can separate from the pressurized gas in the cylinder by gravity. Still, it is also possible to use wet steam in a temperature range which results in the wet steam being condensed by the heat transfer to the gas in the cylinder chamber and its separation in the form of condensate.

The collection pan for the used heat carrier medium is of course closed and maintained under the pressure present in the cylinder chamber. From the collection chamber, the liquid can be released when necessary depending on the liquid level in the collection chamber under the control of a valve. The control may be achieved by a float valve which may also be opened by a gravity flap when sufficient ice crystals have accumulated thereon.

In an embodiment of the thermal engine according to the invention with a reciprocating piston, the cylinder is arranged horizontally and within the cylinder, a cylinder chamber is formed at each side of the piston. The hot heat carrier medium is sprayed alternately in one or the other cylinder chamber to heat the gas in the respective cylinder chamber to heat the gas in the respective cylinder chamber so that the piston is moved out of the respective heated cylinder chamber toward the other cylinder chamber.

In the embodiment of the thermal engine with a rotary piston formed like a Wankel engine piston, the rotary piston has about a triangular cross-section forms between itself and the inner wall of the housing three chambers which rotate with the rotary piston and, in the process, change their volume. Herein the hot heat carrier medium is injected always at the same location. While the respective chamber moves on with the rotation of the piston, the cooled heat carrier medium separated from the gas by gravity separation reaches the outlet openings leading to the collection chamber. The circumferential direction following are of the housing wall is cooled so that the gas is cooled down while the respective chamber moves on with the rotation of the piston up to the position where hot carrier medium is again injected.

The gas in the cylinder- or, respectively, operating chambers is preferably air, but it may be another gas. Since, because of the constant exposure to the liquid heat carrier, medium, gas may be dissolved in the liquid carrier medium and be discharged from the engine together with the used heat carrier medium, the cylinder or respectively, the housing is provided with a gas inlet valve through which pressurized gas from a pressurized gas source may flow into the cylinder chambers or operating chambers so as to maintain the gas pressure therein.

The cylinder or housing wall may be cooled by a coolant which circulates through cooling channels formed with the cylinder or housing walls. As coolant also a refrigerated medium may be used which cools the cylinder or housing walls for below ambient temperature in order to speed up the cooling of the gas and to generate as large as possible a temperature difference between the hot liquid heat carrier medium and the gas at the time when the heat carrier medium is injected. In this case, the cylinder housing wall is insulated against the ambient or surrounding air by an insulation to prevent heat from the ambient to reach the cylinder or housing wall.

The cooling effect however can also be obtained by a thermodynamic process as it is known from the Stirling refrigeration machine wherein a closed air volume is isothermically compressed isochronically cooled, isothermically compressed, isochronically heated. This occurs by a recuperator provided in the piston bottom for intermediate energy storage and flow to the opposite side.

In an embodiment of the thermal engine with a rotary piston, a reversal of the piston is of course not necessary since the piston rotates continuously. In the embodiment with a reciprocating piston, a cyclic switchover is required by which the introduction of the heat carrier medium into the one or into the other cylinder chamber is controlled. This can be done by controlled valves, for example, in the form of a rotary slide valve, for controlling the admission of the hot heat carrier medium into the one or the other cylinder chamber and to interrupt the admission intermittently for a short time.

The valve control may depend on the piston position which is detected by mechanical or other types of sensors which are either assigned to the cylinder chambers for sensing the piston reaching the respective predetermined end position or which are arranged in an intermediate area of the cylinder for the detection of counter elements provided on the circumference of the piston. For the cooling of the operating gas, the recuperator is arranged between the exhaust and the inlet.

The piston is preferably in the form of a plunger piston which has a relatively large axially extending piston skirt so that in its inner area a large cavity is provided whereby the volume of the cylinder chambers are increased. With the large axial length of the piston skirt, the gap between the piston skirt and the cylinder wall can be so selected that the piston is slidingly supported so to speak on a gas film whereby because of the length of the thin gap a good sealing effect is obtained. However, also Teflon tracks may be provided. In the cylinder wall, saw tooth-like grooves 222 may be provided whereby the pressure is reduced by labyrinth effects. Since the cylinder is arranged horizontally, the piston may be provided at its lower area with rollers in order to avoid friction losses.

The power take-off of the thermal engine can be achieved in the embodiment with reciprocating piston in the usual way by means of a connecting rod which extends through the end wall of one of the cylinder chambers. The piston may also be in the form of a free piston and the piston skirt may in the center area of the cylinder cooperate with piezo generators as they are disclosed for example in the European patent EP 2 013 965 B whose step piezo packets co-operate with the piston skip and convert the linear movement of the piston into electric current.

However, also conventional linear generators may be used. Herein, the piston may be provided with one or several annular magnets which moves or which move with the piston within a stator extending over a certain length wherein these annular magnets and the stator form a linear electric power generator.

In the embodiment with a rotary piston, power output is provided via the crankshaft. But also in this case, piezo generators can generate electric power directly via a disc or drum which is driven by the rotary piston shaft as described in the European patent EP 2 013 965 mentioned earlier.

In the linear generator, fluid can be supplied via the piston rod and its admission can be controlled by two rotary pistons with displaced passages and which can be rotated relative to each other and on of which may be stationary while the other is rotatable by a servomotor. Gases or air can be precompressed before injection by an associated piston.

At a cylinder front wall as well as at both walls of the triangular piston bottom large air flow valves are provided which are controlled by the piston via a push rod. In the center position, the gas or air flows through the recuperator whereby the refrigeration effect is provided.

The valve flap provided on the cylinder front wall is operated by an outwardly opening elbow lever and biased by a spring to a closed position. The flap valve have large passage openings which are provided in the respective wall displaced from one another so that only small valve flap movements are necessary to permit passage of large gas volumes.

The cylinder wall of the compression piston is provided with excess pressure valve which are effective in both flow directions, that is for suction and, in case of excess pressure, also for opening in the opposite direction.

In order to permit the utilization of large energy ranges of the warm water, the water injected or sprayed into the chambers may include antifreeze effective for example down to −50° C. and it can be circulated in the motor vehicle through hthe common air cooler and heated by the ambient air so that an automobile may be operated by ambient temperature air.

Below, exemplary embodiments of the invention will be described in greater detail with reference to the accompanying drawings.

### BRIEF DESCRIPTION OF THE DRAWING

FIG. 1 shows a thermal engine according to the invention with a reciprocating piston in an axial cross-sectional view,

FIG. 2 shows a part of the thermal engine according to FIG. 1 in an enlarged representation,

FIG. 3 shows in a schematic representation, a thermal engine according to the invention with a rotary piston in a vertical cross-sectional and with a recuperator for back flow cooling,

FIG. 4 shows a thermal engine according to the invention with sheet metal construction including a reciprocating piston in an axial cross-sectional view and with a piston compressor including a piston rod, and

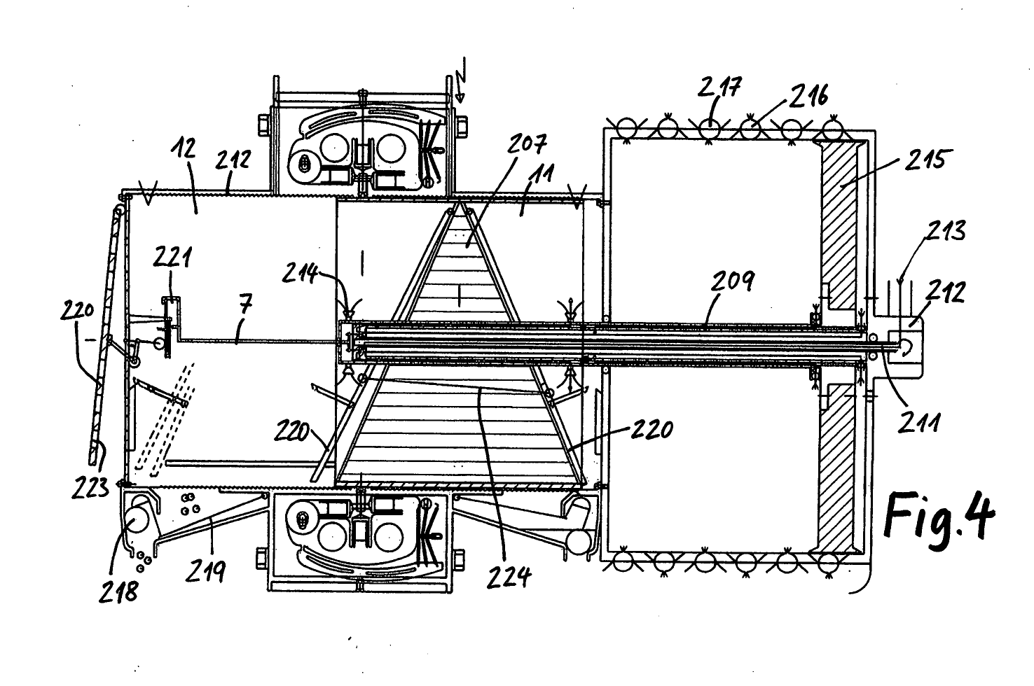

FIG. 5 shows a section of FIG. 4 showing a double piston for the controlled injection via the piston rod.

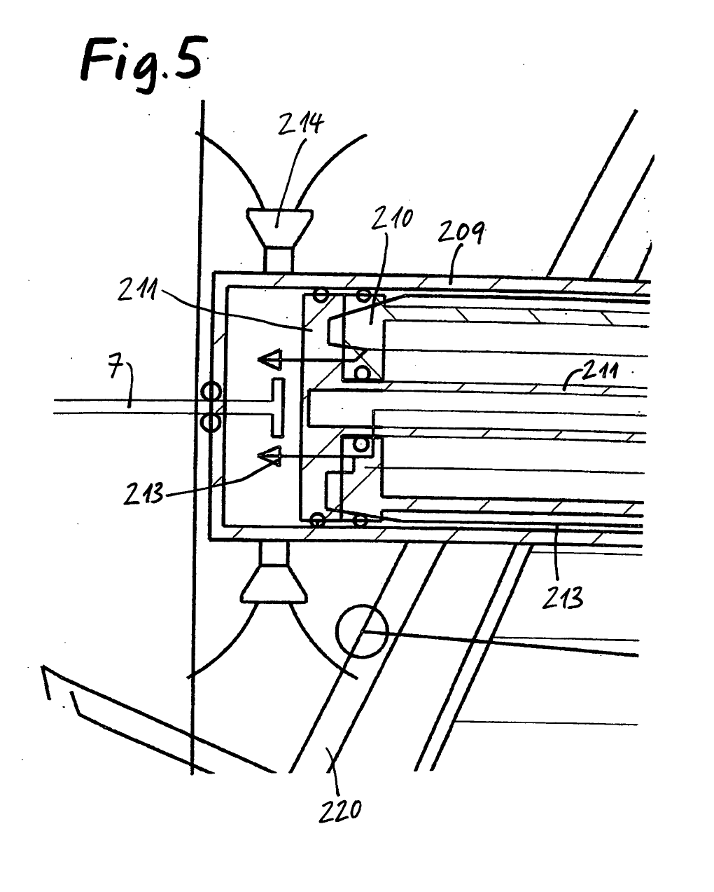

### DESCRIPTION OF EXEMPLARY EMBODIMENTS

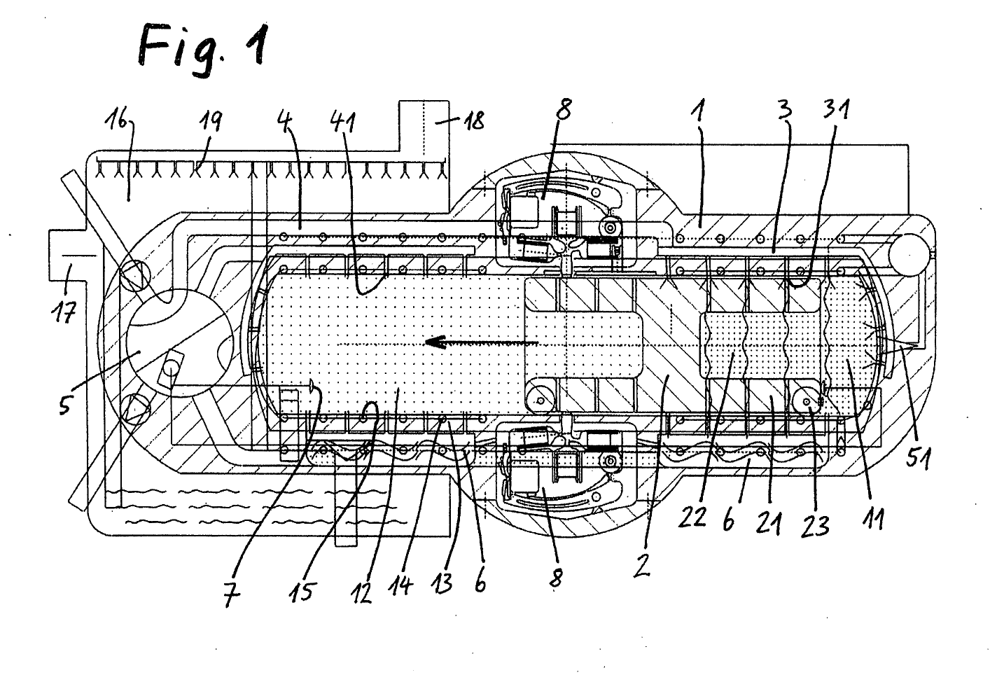

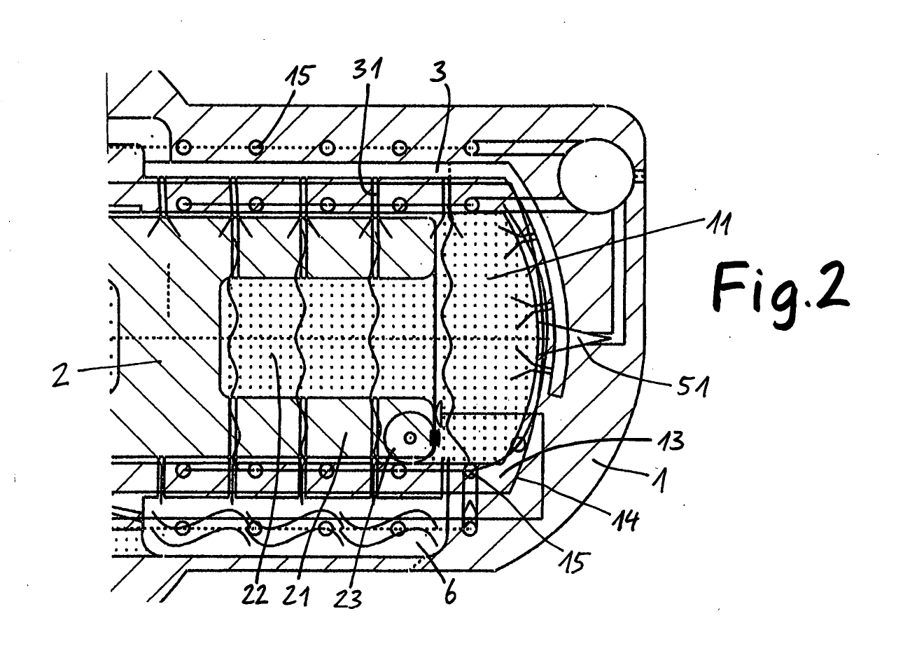

FIGS. 1 and 2 show in each case in an axial cross-section, a thermal engine according to the invention with reciprocating piston and a horizontally arranged cylinder.

The cylinder 1 includes a piston 2 which is movable back and forth in the cylinder 1 and two cylinder chambers 11 and 12 which are disposed at opposite sides of the piston and which are filled with a pressurized gas, preferably air.

The piston 2 is in the form of a freely movable piston which includes a piston skirt 21 of substantial axial length and is provided at both sides with large cavities 22 which increase the volume of the respective cylinder chambers. Between the piston 2 and the cylinder wall 13, there is a thin sealing gap which acts as a labyrinth seal and which practically lets the piston 2 slide on a gas cushion. In addition, the piston is provided in the lower area thereof with rollers 23 which facilitate a low-friction movement of the piston in the cylinder 1.

The cylinder wall 13 includes passages 3 and 4 for supplying a hot heat carrier medium, in particular hot water into the one or the other cylinder chamber 11, 12, which passages end in spray nozzles 31, 41 in the upper area and preferably also in the end wall areas of the respective cylinder chambers 11, 12. A control valve 5 which is shown in FIG. 1 for example as a rotary slide valve controls the supply of hot heat carrier medium from a heat carrier medium source to the one or the other cylinder chamber 11, 12 and also to the intermediate short interruptions.

The cylinder wall 13 is also provided with a heat insulation 14 so as to avoid the inflow of heat from without the cylinders. Within the heat insulation 14, the cylinder wall is provided with cooling channels 15 through which a coolant flows for cooling the cylinder wall to permit the cooling of the gas in the cylinder chambers. In the exemplary embodiment, the coolant is circulated through the cooling channels 15 by a coolant pump 16. In this way, the cylinder wall is constantly cooled.

In the FIGS. 1 and 2, the piston 2 is shown in the right end position within the cylinder 1. The gas in the left cylinder chamber 12 is relatively de-pressurized and relatively cool whereas the gas in the right cylinder chamber 1 is compressed.

In this piston position, now hot heat carrier medium, in particular hot water, is injected into the right cylinder chamber 11 as indicated in the figures. As a result, the gas in the cylinder chamber 11 is heated and expands that is, its pressure is increased so that the piston is driven to the left. The injected liquid hot heat carrier medium flows as a result of gravity through the cylinder chamber 11 and is collected in the bottom area of the cylinder chamber from where it flows through openings into a collection chamber 6. From the collection chamber 6, the collected cooled liquid heat carrier medium is discharged by a valve controlled depending on the liquid level of the collected liquid. The controlled valve may be a float valve.

Upon reaching the left end position of the piston 2 in the cylinder 1, the procedure is reversed. To this end, the control valve 5 directs the supply of the hot liquid heat carrier medium to the other that is now the left cylinder chamber 12. The gas in the right cylinder chamber 11 has already been cooled down to some degree by generating power and is now further cooled by the cooled cylinder wall.

The cylinder wall may be constantly cooled since the high and rapid heat input by the injected hot heat carrier medium transfers heat directly and rapidly to the gas to expand the gas and generate power before the gas is again further cooled at the cylinder wall.

For the reversing control of the piston 2 mechanical or other for example electronic, sensors 7 may be provided which detect the arrival of the piston 2 in the respective end position and which initiate the reversal by the reversing control valve 5.

In the exemplary embodiment, the piston is actuated by piezo generators 8, which may be arranged in the center area of the cylinder 1 annularly around the cylinder circumference and which, as mentioned earlier, may correspond to those described in the European patent EP 2 013 965 B1. The step piezo packets of this piezo generated 8 cooperate directly with the piston skirt 21 which, during back and forth movement of the piston, moves in axial direction relative to the stationary piezo generators.

As also described earlier, alternatively another conventional electrical linear generator may be used for converting the piston movement directly into electric energy.

FIG. 2 shows the right part of FIG. 1 in an enlarged representation to more clearly show the various elements.

The left part of FIG. 1 furthermore shows an arrangement for utilizing waste heat for heating the heat carrier medium which was already utilized in the thermal engine, in particular water. Hot exhaust gas for example from a combustion process is conducted via an inlet 17 and an outlet 18 through a chamber 16, and in the process, transfers its heat to water which is injected at a low temperature via spray nozzles 19 into the chamber 16. The cold spray water is heated in this way by the hot exhaust gas of the combustion process and is collected in the lower area of the chamber 16 from where it is conducted as heat carrier medium to the thermal engine.

In the right end area of the cylinder 1, there is further a pressurized gas refill valve 51 provided via which pressurized gas can be supplied to the respective cylinder chamber 11 when the gas pressure in the cylinder chambers 11 and 12 should drop since gas dissolved in the liquid used heat carrier medium is carried out of the system together with the heat carrier medium.

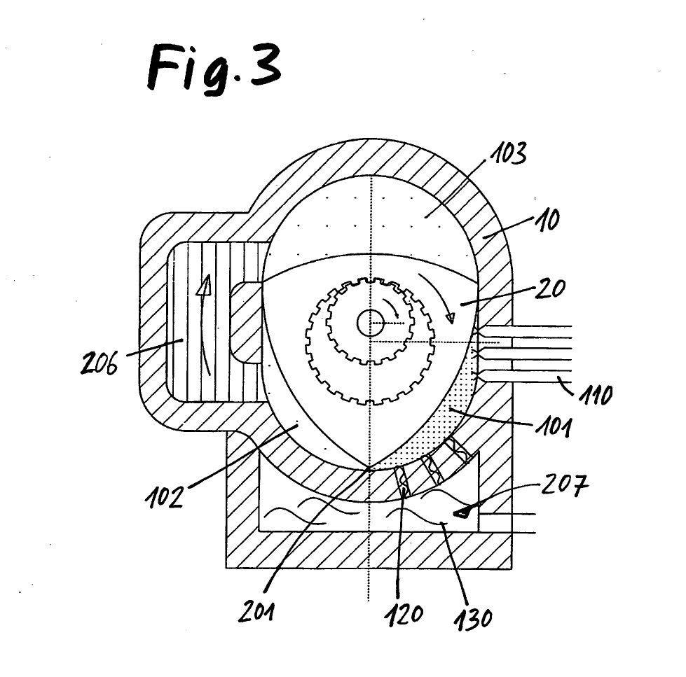

FIG. 3 shows an embodiment of the thermal engine according to the invention with a rotary piston in a cross-section normal to the engine axis. The cylinder 10 and the rotary piston 20 have the form known from a Wankel engine. The rotary piston is triangular in cross-section with rounded side walls and three sealing edges 201 which slide along the interior walls of the cylinder 10. The three seal edges of the rotary piston 20 form with the interior wall of the cylinder 10, three chambers 101, 102, 103 which rotate with the rotary piston in the direction as indicated by an arrow and which in the process, change their volume.

By a control valve, which is not shown, hot heat carrier medium is supplied via an inlet 110 to the respective cylinder chamber while it is in the area of the inlet 110. In the area of the inlet 110 the volume of the respective cylinder chamber which changes during rotation in the cylinder, in small and the gas is compressed. With the injection of the heat carrier medium the gas is heated whereby its pressure is increased. As the respective chamber moves on, it reaches the area of the discharge openings 120 which lead to a collecting chamber for the used heat carrier medium. From the collection chamber 130. The used heat carrier medium can be discharged, depending on the level of the heat carrier medium, for example controlled by a float valve 218 with a control flap 219 as described already earlier. With further rotation, the chamber volume increases as the gas pressure and its temperature rapidly drop. A cooling of the cylinder wall outside the cylinder wall area, in which the hot heat carrier medium is injected, is advantageous and can be provided for in a manner similar to that described with regard to the embodiment shown in FIGS. 1 and 2.

In the recuperators 206, 207, there are for example cupper fibers to which the heat, which is generated in the cold area by compression, is transferred and stored and then transferred to the previous compression chamber 208 which meanwhile cooled down and in which the pressure has become lower by power generation and as a result provides for the desired air cooling effect of the operating air in the cylinder chamber 11 or respectively 12 or respectively 103.

On the piston rod 209, there are so-called impact nozzles 214 via which the warm air or the warm water is injected under the control of the servo motor 212 in that the servomotor rotates the rotary piston so as to open corresponding passages with respect to the stationary piston 210.

The water inlet 213 supplied water to the input nozzles 214 via the inner tube 211.

The compression piston 215 is also driven by the piston rod 209 and sucks in, via the inlet valves 216, the wet steam or warm air, compresses them and passes them on. Pressure limiting valves 217 open when the pressure becomes excessive.

The float valves 218 and 219 as well as 207 are provided with ice flaps which upon formation of a sufficient amount of ice crystals will open by gravity the float valves so as to release the crystals for removal.

What is claimed is:

1. A method for operating a thermal engine for generating electricity or mechanical power, wherein a piston (2, 20) is driven by hot gas which is disposed under pressure in a cylinder chamber (11, 12, 101, 102, 103) of a cylinder (1, 10) of the thermal engine and which is heated by a heat supply from without, said method comprising the steps of supplying heat to the hot gas in the cylinder chamber by injecting or spraying a hot heat carrier medium in a liquid or wet steam-like state into the cylinder chamber and collecting the used heat carrier medium as a liquid or in the form of ice crystals in a bottom area of the cylinder chamber for transfer into a collection chamber.

2. The method according to claim 1, wherein the heat carrier medium is injected or sprayed alternately into the one (11) or the other (12) of two cylinder chambers (11, 12) which are disposed at opposite sides of a piston (2) which is movably back and forth in a horizontally arranged cylinder (1).

3. The method according to claim 1, wherein the heat carrier medium is injected or sprayed into the cylinder chamber (101, 102, 103) formed in a certain circumferential area of a cylinder (10) between the cylinder wall and a rotational piston (20) rotating in the cylinder.

4. In hot gas thermal engine having a cylinder (1) with a piston (2, 20) movably disposed in the cylinder (1) and actuated by hot gas which is heated by heat supplied to the respective cylinder chamber (11, 12, 101, 102, 103), the improvement wherein injection means (31, 41, 110) are provided for injecting or spraying a hot heat carrier medium in a liquid or wet stream state into the respective cylinder chamber as well as collection means for collecting used heat carrier medium in a liquid state in a bottom area of the respective cylinder chamber.

5. The hot gas thermal engine according to claim 4, with a reciprocating piston (2) wherein the cylinder (1) is arranged horizontally and a control arrangement is provided for controlling the means for injecting or spraying the hot heat carrier medium so as to inject or spray the heat carrier medium in each case based on the respective piston position alternately into the one (11) and the other (12) of two cylinder chambers (11, 12) arranged axially at opposite sides of the piston (2) disposed reciprocatingly in the cylinder (1).

6. The hot gas thermal engine according to claim 5, wherein the cylinder wall (13) is constantly cooled.

7. The hot gas thermal engine according to claim 4, wherein the piston (2) is a rotary piston (20) according to the principle of the Wankel engine, wherein, between the piston (20) and the cylinder wall (110), cylinder chambers (101, 102, 103) are formed whose volumes change during rotation of the piston and wherein the injection means for injecting or spraying the heat carrier medium are arranged in a predetermined area of the circumference of the cylinder.

8. The hot gas thermal engine according to claim 7, wherein in an area, which is circumferentially spaced from the area where the heat carrier medium is injected or sprayed into the cylinder, the cylinder wall (110) is provided with cooling channels (13) for cooling the cylinder wall.

9. The hot gas thermal engine according to claim 8, wherein for efficiently cooling the cylinder wall (13, 110) the cooling channels through which a coolant or a refrigerant is conducted extend within the wall around the cylinder.

10. The hot gas thermal engine according to claim 4, wherein a pressurized gas supply valve (51) is arranged in the cylinder wall (13, 110) and connected to a pressurized gas source for compensating for pressurized gas losses.

11. The hot gas thermal engine according to claim 4, wherein the collection means is a collecting chamber (6, 130) for used heat carrier medium and is provided with a discharge valve (218) which is controlled by the liquid level.

12. The hot gas thermal engine according to claim 4, wherein a piezo-electric generator (8) is provided on which the piston (2, 20) acts directly or indirectly and which includes step-piezo packets cooperating directly with the piston (2) or with a member moved by the pistons.

13. The hot gas thermal engine according to claim 12, wherein the piezo-electric generator (8) includes step-piezo packets and the reciprocating piston cooperates with its piston skirt (21) directly with the step-piezo packets of the piezo electric generator (8) which is arranged around the circumference of the piston or the piston (2) is provided with magnet rings and forms, together with an electric stator surrounding the piston, an electric linear generator.

14. The hot gas thermal engine according to claim 5, wherein the piston (2) is provided at its bottom area with rollers (23) which cooperate with the bottom area of het cylinder wall (13).

15. The hot gas thermal engine according to claim 4, wherein a recuperator (206) is provided in one of the bottom area of the piston (207) and the cylinder housing (10) for back cooling of the operating air.

16. The hot gas thermal engine according to claim 4, wherein the piston rod (209) is provided with a compression piston (215).

17. The hot gas thermal engine according to claim 4, wherein ice flaps (219) are provided.

18. The hot gas thermal engine according to claim 4, wherein the injection control includes control pistons (210, 211) which are movable relative to each other and a servomotor (212) for moving the control pistons.
